(19) United States
(12) Patent Application Publication
(10) Pub. No.: US 2022/0088825 A1
(43) Pub. Date: Mar. 24, 2022

(54) SYSTEM AND METHOD OF PROCESSING HOLLOW CORE ELEMENT WITH INTEGRATED WELDING PLATES

(71) Applicant: Concore BV, Helmond (NL)

(72) Inventors: Sven Vallgren, Helmond (NL); J.A.A.M. Tourne, Helmond (NL)

(21) Appl. No.: 17/479,509

(22) Filed: Sep. 20, 2021

Related U.S. Application Data
(60) Provisional application No. 63/080,114, filed on Sep. 18, 2020.

(51) Int. Cl. B28B 17/00; B28B 7/28; B28B 3/22; B28B 23/00

(52) U.S. Cl. CPC B28B 17/0081; B28B 23/0056; B28B 3/228; B28B 7/28

(57) ABSTRACT

A hollow core element forming system including a measuring device configured to determine a location of a welding plate assembly on a casting bed. The welding plate assembly being connected to one or more prestressed strands. A hollow core forming mechanism has a strand guide located at a leading end of a support frame of the hollow core forming mechanism. The strand guide is configured to engage the one or more prestressed strands when the strand guide is in a closed position and to disengage the one or more prestressed strands when the strand guide is in an open position without interference between the strand guide and the welding plate assembly. A strand guide controller unit causes the strand guide to rotate between the open position and the closed position based on the location of the strand guide relative to the welding plate assembly.

### INCORPORATION BY REFERENCE

The present patent application claims priority to the provisional patent application identified by U.S. Ser. No. 63/080,114, filed on Sep. 18, 2020, the entire content of which is hereby incorporated herein by reference.

### BACKGROUND OF THE INVENTIVE CONCEPTS

A hollow core element is a precast slab of concrete constructed with multiple, interior voids extending the length of the slab. The hollow core element can be used for a floor, wall, or ceiling in constructing a building. Many benefits exists for using hollow core elements in construction, including allowing faster on-site assembly, reducing material requirements, and providing greater strength.

There are generally two methods for casting hollow core elements. The first method uses an extruder, which causes feed screws to force a concrete mix around mandrels within a casting mold defined by a casting bed surface, together with side plates and top plates of the extruder. The mandrels define the size and shape of the hollow cores. The extruder moves along the casting bed driven by reaction force from the feed screws extruding the concrete mass and optionally with an additional drive motor.

In the second method, a slipformer feeds the concrete mix to the casting mold in at least two feeding stages. During the first feeding stage, the concrete mix is fed to the lower portion of the casting mold defined by the casting bed surface, together with side plates and top plates of the slipformer. The concrete mix is compacted by vibrating shoes and mandrels before additional concrete mix is fed onto the mandrels and over the poured concrete mix during the second feeding stage for casting the upper portion of the hollow core element. The concrete mix is compacted with a vibrating plate of the slipformer.

In both methods, the hollow core element includes strands of steel wire rope to resist bending moments from loads. The strands of steel wire rope are prestressed along the longitudinal axis of the hollow core element and within the !-beams portion between the longitudinal voids of the cured hollow core element. The strands of steel wire rope are positioned and prestressed within the casting bed before the casting process taking place. The extruder and slipformer include a plurality of static strand guides on the leading edge of the machine to hold the strands of steel wire rope in place during the casting process.

Welding plates are embedded in the hollow core element to connect the hollow core element to the building frame or other hollow core elements to give stability to the construction. The current method for installing the welding plates in the hollow core elements with embedded prestressed strands of steel wire rope involves casting the hollow core element as described above before installing the welding plates. After the hollow core element is cast, the location for the welding plate is manually determined before a hole is created at the determined location. The hole may be formed before or after the concrete has cured. The welding plate is then placed in the hole, under the strands of steel wire rope, before the hole is filled with additional concrete and allowed to cure.

The current method for installing welding plates is time consuming, requires additional concrete material, and can cause a weaker hollow core element. Thus, a need exists for a device and method for casting a hollow core element with an integrated welding plate, while ensuring that the strand guides associated with a hollow core forming mechanism do not interfere with the welding plate.

### BRIEF DESCRIPTION OF THE DRAWINGS

Like reference numerals in the figures represent and refer to the same or similar elements of functions. Implementations of the disclosure may be better understood when consideration is given to the following detailed description thereof. Such description makes reference to the annexed pictorial illustrations, schematics, graphs, drawings and appendices. In the drawings:

FIG. 1 is a schematic illustration of a hollow core forming system constructed in accordance with the inventive concepts disclosed herein.

FIG. 2 is a bottom, perspective view of a hollow core element with prestressed strands and welding plate assemblies embedded therein.

FIG. 3 is a sectional, schematic illustration of the hollow core element shown positioned on a casting bed.

FIG. 4 is a perspective view of a welding plate assembly.

FIG. 5 is a perspective view of the casting bed with the welding plate assemblies positioned thereon and connected to the prestressed strands.

FIG. 6 is a schematic illustration of a measuring device.

FIG. 7 is an exploded, perspective view of a portion of a hollow core forming mechanism.

FIG. 8 is a schematic illustration of another version of a hollow core forming mechanism.

FIG. 9 is front elevational view of a strand guide.

FIG. 10 is an enlarged view of the strand guide of FIG. 9.

FIG. 11 is a partially schematic, partially perspective view of a portion of the strand guide and a control unit.

### DETAILED DESCRIPTION OF EXEMPLARY EMBODIMENTS

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely to differentiate between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

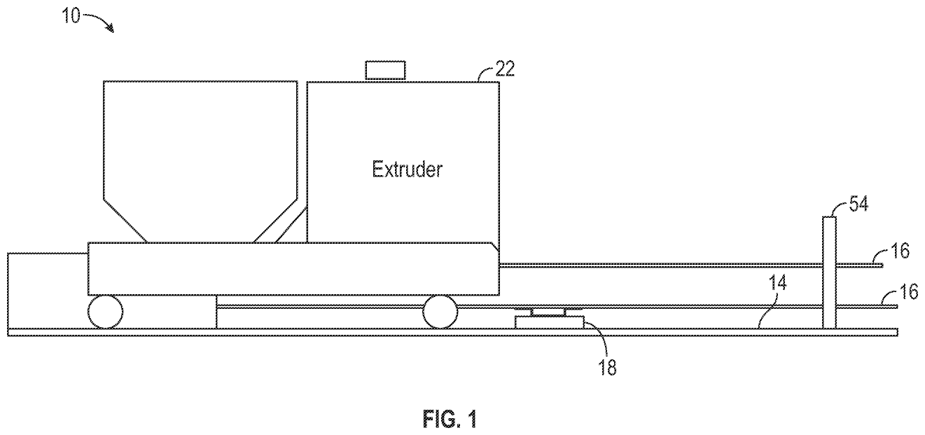

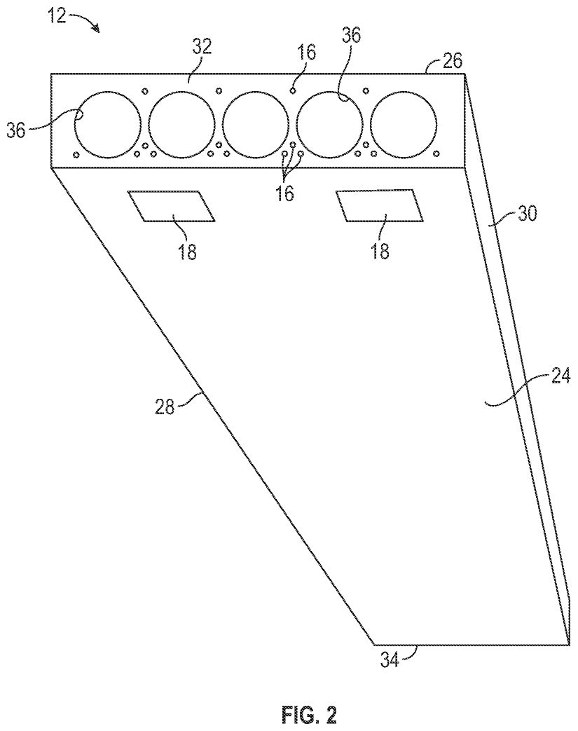

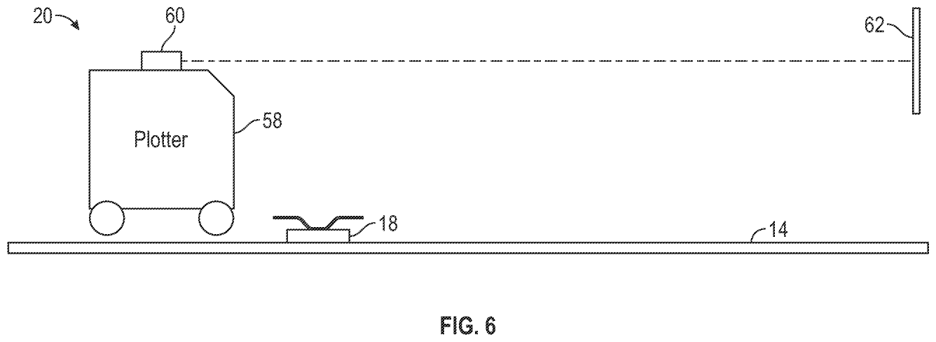

Referring now to the FIG. 1, shown therein is an exemplary embodiment of a hollow core element forming system 10 according to the instant disclosure for forming a hollow core element, such as hollow core element 12 illustrated in FIG. 2. The hollow core element forming system 10 includes a casting bed 14, one or more prestressed strands 16, a welding plate assembly 18, a measuring device 20 (FIG. 6), and a hollow core forming mechanism 22. Generally, the measuring device 20 is used to identify the location of the welding plate assembly 18 on the casting bed 14. The welding plate assembly 18 is positioned on the casting bed 14 at a selected location and the welding plates assembly 18 are attached to one or more of the prestressed strands 16. Using the location of the welding plate assembly 18, the hollow core forming mechanism 20 may cast the hollow core element 12 with the welding plate assembly 18 in position without interference between the hollow core forming mechanism 20 and the welding plate assembly 18.

FIG. 2 illustrates a perspective view of the hollow core element 12 constructed in accordance with the inventive concept disclosed herein. The hollow core element 12 has one or more welding plate assemblies 18 integrated therein. In some embodiments of the presently claimed and/or disclosed inventive concept(s), the hollow core element 12 integrated with the welding plate assemblies 18 may be used as a structural member in constructing a building such as a floor, a wall, or a ceiling, for example.

As shown in FIG. 2, the hollow core element 12 is a formed slab of concrete that broadly comprises a bottom surface 24, a top surface 26, a first side 28, a second side 30, a first end 32, and a second end 34. The bottom surface is the surface in contact with the casting bed 14 during the casting process and will take the form of the casting bed 14. The top surface 26 is parallel to and vertically spaced from the bottom surface 24. The top surface 26 being shaped and formed during the casting process. The first and second sides 28, 30 may be substantially perpendicular to the top and bottom surfaces 26, 24 and parallel to each other. In some embodiments, the first side 28 and the second side 30 may be slightly angled inward from the bottom surface 26 to the top surface 24. In some embodiments, the first side 28 and second side 30 may have a contoured profile.

The hollow core element 12 can be manufactured to various sizes and dimensions in accordance with the present disclosure. The typical dimensions of the hollow core element 12 may include a thickness of approximately four inches to approximately twenty-four inches and a width from approximately twenty inches to approximately one hundred inches. The thickness is the measurement between the bottom surface 24 and the top surface 26, and the width is the measurement between the first side 28 and the second side 30. Regarding the length, the hollow core element 12 may be formed on casting bed 14 that typically ranges from eighty meters to two hundred meters. The final product is cut to the desired length for each project, which may be only several feet long or up to approximately eighty feet long, for example. The length will be defined as the measurement between the first end 32 and the second end 34. It will be understood by a person of ordinary skill in the art that the final thickness, width, and length of the hollow core element 12 may be determined according to the structural requirement, design schemes, or architectural application of the hollow core element 12.

The hollow core element 12 includes one or more longitudinal voids 36 extending from the first end 32 to the second end 34, and substantially centered between the top surface 26 and the bottom surface 24. In one embodiment, the longitudinal voids 36 may be substantially equally spaced in a single row between the first side 32 and the second side 34. A cross-sectional shape and a cross-sectional size of the longitudinal void 36 may vary based on the structural requirements of the hollow core element 12. For example, the cross-sectional shape of the longitudinal void 36 is depicted in FIG. 2 as having a circular shape. However, it will be understood that the cross-sectional shape of the longitudinal void 36 may include, but is not limited to a square shape, a elliptical shape, an oval shape, a polygonal shape, or any combination thereof. To ensure there is a sufficient thickness of concrete between the longitudinal void 36 and the top surface 26 and the bottom surface 24, a cross-sectional height of the longitudinal void 36 may be limited by the thickness of the hollow core element 12. Similarly, to ensure a minimal thickness of concrete exist between the one or more longitudinal voids 36, the first side 28, and the second side 30, a cross-sectional width of the longitudinal void 36 may be limited by the width of the hollow core element 12 and the number of longitudinal voids 36 present within the hollow core element 12 to ensure a minimal thickness of concrete exist between the one or more longitudinal voids 36, the first side 28, and the second side 30.

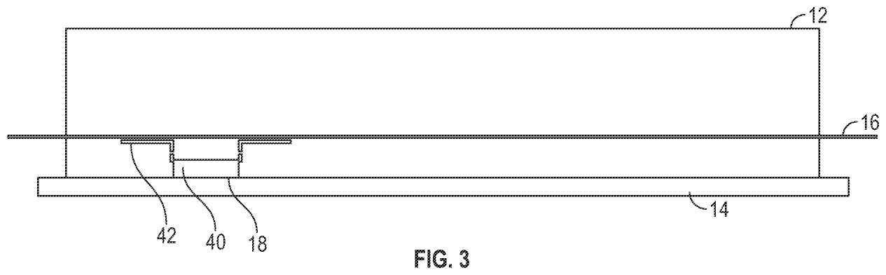

Referring to FIGS. 2 and 3, in one embodiment, the hollow core element 12 includes one or more prestressed strands 16 extending longitudinally from the first end 32 to the second end 34. The number and location of the one or more prestressed strands 16 will be determined by the structural requirements of the hollow core element 12. The one or more prestressed strands 16 may be positioned within the hollow core element 12 so the one or more prestressed strands 16 is entirely encased in concrete. In one embodiment, the one or more prestressed strands 16 may be encased within the concrete between the longitudinal void 36 and the bottom surface 24. In one embodiment, the one or more prestressed strands 16 may be encased within the concrete between the longitudinal void 36 and the top surface 26. In one embodiment, the one or more prestressed strands 16 may be encased within the concrete between the one or more longitudinal voids 36, the first side 28, and the second side 30.

In one embodiment, the one or more prestressed strands 16 may be steel wire rope or cable. The one or more prestressed strands 16 may be single-strand wire or multi-strand wire having an overall diameter between approximately a quarter of an inch to approximately one inch. In one embodiment, the one or more prestressed strands 16 may be prestressed before forming the hollow core element 12 and held in tension during the casting process so the one or more prestressed strands 16 remain in tension after the hollow core element 12 is cured.

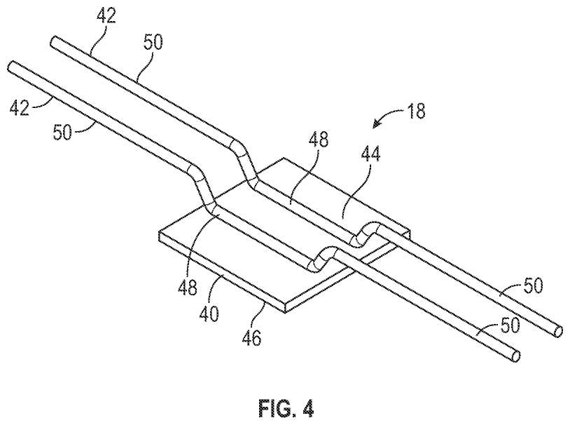

Referring to FIG. 4, the hollow core element 12 includes one or more welding plate assemblies 18. The one or more welding plate assemblies 18 may include a welding plate 40 and at least one attachment arm 42. The welding plate 40 has an exterior surface 44 and an interior surface 46.

In one embodiment, the welding plate 40 may be a metal plate having a thickness between approximately three-sixteenths of an inch to approximately two inches, the thickness of the welding plate 40 is the distance between the exterior surface 44 and the interior surface 46. Although the welding plate 40 is depicted as having a square shape, it should be appreciated that welding plate 40 having other shapes including but not limited to oval, rectangular, circular, triangular, and irregularly shapes may also be used. The welding plate 40 may be constructed of a material suitable for welding, such as, carbon steel, stainless steel, cast iron, aluminum, titanium, copper, nickel, and any other like material. In one embodiment, the exterior surface 44 of the welding plate 40 is coplanar with the bottom surface 24, while the interior surface 46 and the attachment arms 42 are embedded in the concrete of the hollow core element 12.

In one embodiment, the attachment arms 42 may be constructed of a bar material including a proximal portion 48 and a distal portion 50. The proximal portion 48 of the attachment arms 42 may be fixed to the interior surface 46, by welding. The distal portion 50 of the attachment arms 42 are bent to extend away from the interior surface 46 and are spaced from one another to be connectable to the prestressed strands 16. In one embodiment, the distal portions 50 may be connected to the prestressed strands 16 with tie wire (not shown) or some other suitable fastener or manner.

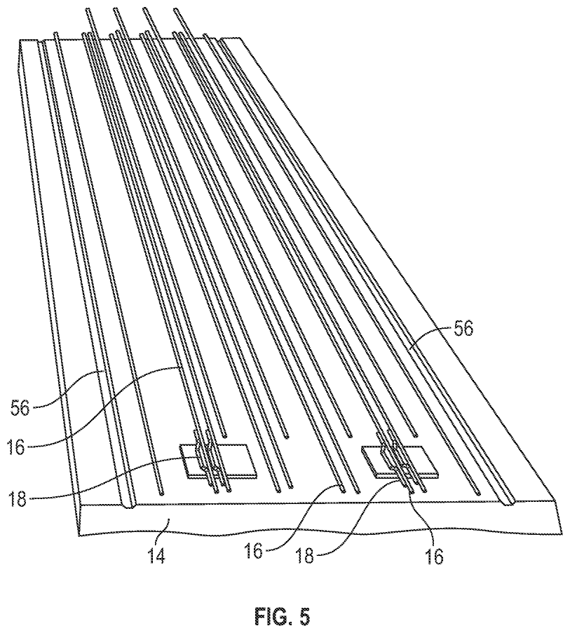

The casting bed 14, as shown in FIG. 1, is a substantially flat, horizontal surface having a longitudinal axis. The casting bed 14 may be constructed of a rigid material, such as concrete, steel, or combination thereof. The casting bed 14 may include a strand tensioning plate 54 at each end of the casting bed 14 configured to receive the steel wire or cable and hold the prestressed strands 16 under tension during the casting process. In some embodiments, the casting bed 14 may include a set of rails 56 (FIG. 5) that run parallel to the longitudinal axis along the outside edge of the casting bed 14 configured to provide a track for wheeled equipment, such as the measuring device 20 and the hollow core forming mechanism 22.

Referring to FIG. 6, the measuring device 20 determines the location of the welding plate assembly 18 on the casting bed 14. The measuring device 20 may be attached to a mobile platform, such as a mobile plotter 58 or the hollow core forming mechanism 22, configured to be repositioned along the longitudinal axis of the casting bed 14. The measuring device 20 may include a laser 60 and a reflector 62 located at the end of the casting bed 14. The measuring device 20 determines the location based on a time factor associated with return of the laser beam from the reflector 62. In another embodiment, the measuring device 20 can use radio frequency (RF), infrared (IR), optical sensors, sonar, or GPS technology to determine the location of the welding plate assemblies 18. It should be understood that other types of measuring devices may be used to determine the location of the element, feature, or component associated with the hollow core element 12 within the casting bed 14, including a tape measure.

In one embodiment, the measuring device 20 may be associated with the mobile plotter 58, or marking robot, configured to provide an indication for the location of the element, feature, or component associated with the hollow core element 12 on the casting bed 14 as determined by the measuring device 20.

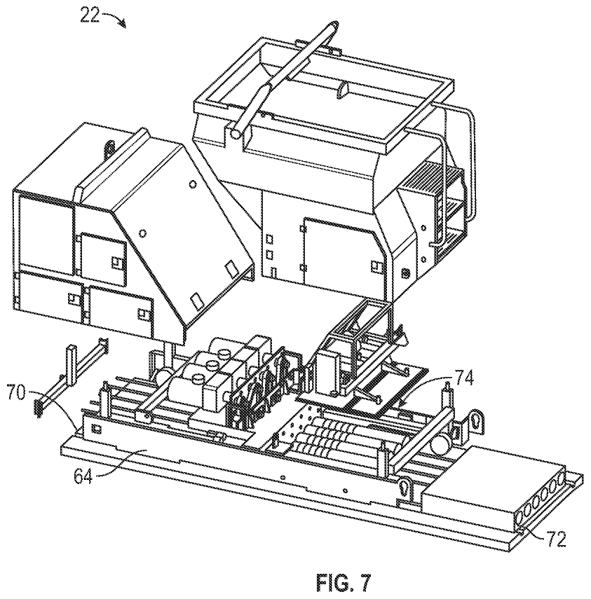

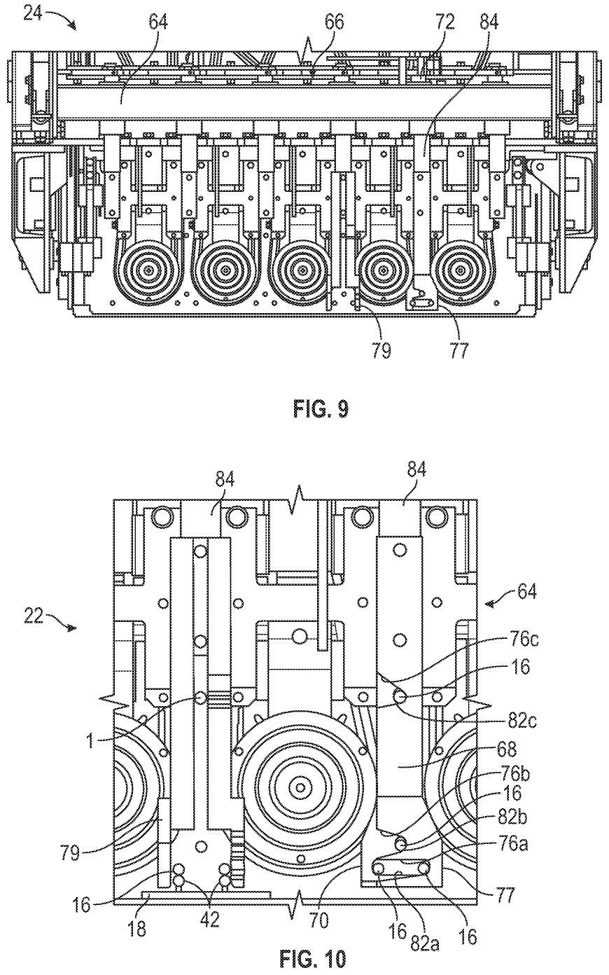

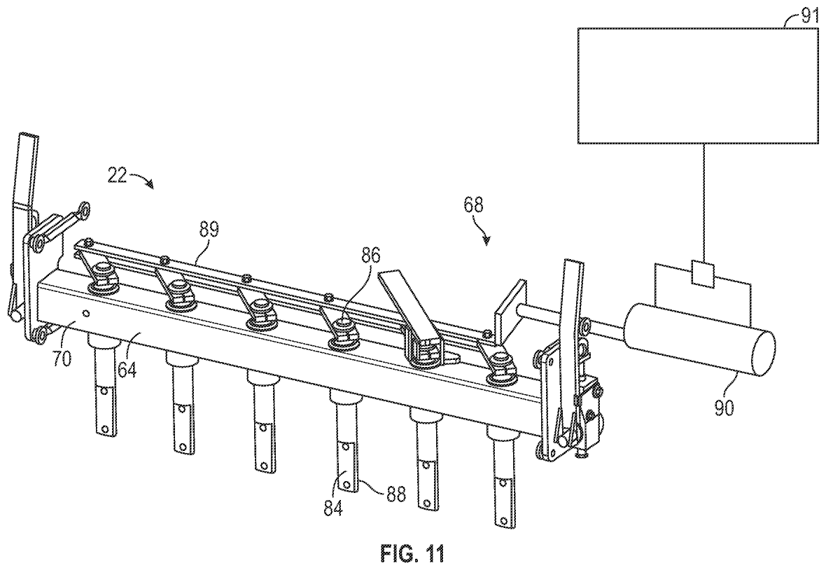

Turning now to FIGS. 7-11, the hollow core forming mechanism 22 may be used to form the hollow core element 12 with the integrated welding plate assemblies 18 described above. The hollow core forming mechanism 22, referred to as a slipformer or extruder, is a well-known device in the hollow core industry. The hollow core forming mechanism 22 is supported by the casting bed 14 and aligned with the longitudinal axis. The hollow core forming mechanism 22 may be configured to continuously reposition along the longitudinal axis of the casting bed 14 while forming the hollow core element 12. The hollow core forming mechanism 22 broadly comprises a support frame 64, a strand guide 66 (FIGS. 9-11), and a strand guide control unit 48 (FIG. 11).

The support frame 64 comprises a leading end 70, a trailing end 72, and a hollow core element forming zone 74, wherein the hollow core element forming zone 74 is between the leading end 70 and the trailing end 72. The support frame 64 provides a rigid platform for the various components of the hollow core forming mechanism 22. In one embodiment, the support frame 64 may have one or more sets of wheels (not shown) that align with set of rails 56 of the casting bed 14.

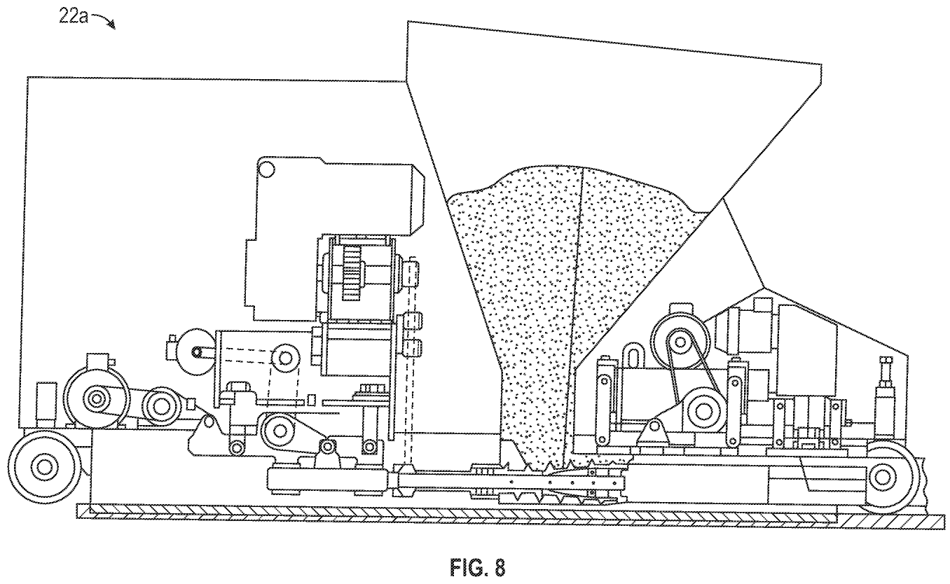

FIG. 8 illustrates another version of a hollow core forming mechanism 22a.

The strand guide 66 is located at or near the leading end 70 and is configured to engage the one or more prestressed strands 16 when the strand guide 66 is in a closed position (denoted by reference numeral 77) and to disengage the one or more prestressed strands 16 when the strand guide 66 is in an open position (denoted by reference numeral 79) without interference between the strand guide 66 and the welding plate assembly 18. The strand guide 66 includes a first guide member 68 and a second guide member 70 arranged so the first guide member 68 and the second guide member 70 cooperate to engage and support the prestressed strands 16 as the hollow core forming mechanism 22 is traveling along the casting bed 14 and to disengage the prestressed strands 16 as the first guide member 68 and the second guide member 70 travel past the welding plate assembly 18. In one embodiment, the first guide member 68 is a flat bar with a proximal end 72 and a distal end 74. The distal end 74 has an interior side with a plurality of slots 76a-76c configured to receive one or more of the prestressed strands 16. The second guide member 70 can be a mirror image of the first guide member 68 so the second guide member 70 is a flat bar with a proximal end 78 and a distal end 80. The distal end 80 of the second guide member 70 has an interior side with a plurality of slots 82a-82c configured to receive one or more of the prestressed strands 16. The first guide member 68 and the second guide member 70 are supported relative to one another in a spaced, parallel relationship so in the closed position 77 the first guide member 68 and the second guide member 70 are arranged perpendicular to the prestressed strands 16 so the prestressed strands 16 are positioned in the slots 76a-76c of the first guide member 68 and the slots 82a-82c of the second guide member 70 and in the open position 79 the first guide member 68 and the second guide member 70 are arranged parallel to the prestressed strands 16 so the prestressed strands 16 are removed from the slots 76a-76c of the first guide member 68 and the slots of 82a-82c of the second guide member 70 in a way that allows the first guide member 68 and the second guide member 70 to pass by the attachment arms 42 of the welding plate assembly 18. It will be understood the strand guides 66 will be moved in unison between the closed position 77 and the open position 79. FIGS. 9 and 10 have illustrated one of the strand guides being in the open position 79 while the other strand guides 66 are in the closed position 77 for purposes of illustration only.

It will be appreciated the number of strand guides 66 may be varied to correspond with the number of groups of prestressed strands 16 used in the hollow core element 12. Also, the number and configuration of the slots in the first guide member 68 and the second guide member 70 may be varied depending on the number and arrangement of the prestressed strands 16 in the hollow core element 12.

The strand guide 66 further includes a support rod 84. The rod support 84 has a proximal end 86 and a distal end 88. The proximal end 86 is rotatably connected to the support frame 64 with the support rods 84 of each of the strand guides 66 spaced apart so as to be located between the coring elements of the hollow core forming mechanism 22. The first guide member 68 and the second guide member 70 are connected to opposite sides of the distal end 88 of the support rod 84.

The control unit 68 controls the position of the strand guides 66 based on the location of the strand guides 66 relative to the welding plate assembly 18. The control unit 68 can comprise a yolk 86 attached to each of the support rods 84, a linear actuator 90 for moving the yoke 86, and a controller 91 for selectively energizing the actuator 90. The linear actuator 88 may be operated hydraulically, pneumatically, or electrically. In another version, the controller 91 may include servo motors (not shown) for rotating each of the support rods 84. The servo motors are in turn controlled by the controller 91. The controller 91 may include one or more processors capable of executing processor executable code, one or more non-transitory memory capable of storing processor executable code, an input device, and an output device, all of which can be located on the hollow core forming mechanism 22, or partially or completely network-based or cloud-based, and not necessarily located in a single physical location.

The controller 91 is arranged to control and coordinate operations of the strand guides 66, and in particular to receive data indicative of the current position of the hollow core forming mechanism 22 relative to the welding plate assemblies 18, and to use the received data to derive control parameters for the actuator or servo motors to position the guide strands 66 in the open position or the closed position.

The controller 91 may be implemented in any suitable way, and in this example the controller 91 is implemented using a programmable logic controller (PLC) or a personal computing device provided with appropriate software and interfaces to implement desired functionality. The data in this example includes data indicative of a position of the welding plate assemblies 18 relative to a reference point, such as a wall located at an end of the casting bed 14.

In one embodiment, the controller 91 may include a laser or radio frequency signals directed at the reference point to measure the distance of the hollow core forming mechanism 22 from the reference point. The controller 91 may include a touch screen display, which may form an input device for inputting the distance of the welding plate assemblies 18 determined by the measurement device 20. The touch screen display may be equipped with a graphical user interface (GUI) capable of communicating information to the user and receiving instructions from the user.

In operation, the welding plate assemblies 18 are positioned on the casting bed 14 where desired. The position of the welding plate assemblies 18 is determined by the measurement device 20. A series of the prestressed strands 16 are extended over the casting bed 14. The welding plate assemblies 18 are tied or otherwise connected to the prestressed strands 16. The position of the welding plate assemblies 18 is entered into the controller 91. The hollow core forming mechanism 22 is operated to form a hollow core element 12 with the strand guides 66 supporting the prestressed strands 16 in the closed position 77 as the hollow core element 12 is being formed. Upon the hollow core forming mechanism 22 coming upon the welding plate assemblies 18, the controller 91 signals the actuator or servo motors to rotate in a way to move the strand guides 66 to the open position 79 so as not to interfere with the welding plate assemblies 18. Upon passing the welding plate assemblies 18, the controller 91 signals the actuator or servo motors to rotate in a way to move the strand guides 66 to the closed position 77.

While the present disclosure has been described in connection with certain embodiments so aspects thereof may be more fully understood and appreciated, it is not intended that the present disclosure be limited to these particular embodiments. But it is intended that all alternatives, modifications and equivalents are included within the scope of the present disclosure. Thus the examples described above, which include particular embodiments, will illustrate the practice of the present disclosure, it being understood that the particulars shown are by way of example and for illustrative discussion of particular embodiments only and are presented in the cause of providing what is believed to be the most useful and readily understood description of procedures and of the principles and conceptual aspects of the presently disclosed methods and compositions. Changes may be made in the structures of the various components described herein, or the methods described herein without departing from the spirit and scope of the present disclosure.

What is claimed is:

1. A hollow core element forming system, comprising:
a casting bed having a longitudinal axis and a casting surface;
one or more prestressed strands extending along the longitudinal axis of the casting bed, wherein the one or more prestressed strands are vertically spaced from the casting surface;
a welding plate assembly having an external surface, an internal surface, and at least one attachment arm, the external surface positioned on the casting surface, and the attachment arm extending from the internal surface and attached to at least one of the one or more prestressed strands;
a measuring device configured to determine a location of the welding plate relative to the casting bed; and
a hollow core forming mechanism aligned with the longitudinal axis, the hollow core forming mechanism configured to travel along the longitudinal axis of the casting bed while forming a hollow core element having embedded prestressed strands, the hollow core forming mechanism comprising:
a support frame comprising a leading end, a trailing end, and a hollow core element forming zone, the hollow core element forming zone located between the leading end and the trailing end;
a strand guide located at the leading end of the support frame, the strand configured to engage the one or more prestressed strands when the strand guide is in a closed position and to disengage the one or more prestressed strands when the strand guide is in an open position without interference between the strand guide and the welding plate assembly; and
a strand guide controller unit configure to move the strand guide between the open position and the closed position based on the location of the strand guide relative to the welding plate assembly based on the location of the welding plate relative to the casting bed determined by the measuring device.

2. The hollow core element forming system of claim 1, wherein the one or more prestressed strands are parallel to the casting surface.

3. The hollow core element forming system of claim 1, wherein the hollow core forming mechanism is supported by the casting bed.

4. The hollow core element forming system of claim 1, wherein moving the strand guide between the open position and the closed position is defined further as rotating the strand guide between the open position and the closed position.

5. The hollow core element forming system of claim 1, wherein the measuring device is attached to a mobile platform movable along the casting bed.

6. The hollow core element forming system of claim 5, wherein the measuring device comprises a laser mounted on the mobile platform and a reflector at one end of the casting bed.

7. A hollow core forming mechanism, comprising:
a support frame comprising a leading end, a trailing end, and a hollow core element forming zone, the hollow core element forming zone located between the leading end and the trailing end;
a strand guide located at the leading end of the support frame, the strand configured to engage one or more prestressed strands when the strand guide is in a closed position and to disengage the one or more prestressed strands when the strand guide is in an open position, wherein in the open position the strand guide forms a channel sized and dimensioned to pass a welding plate assembly having a predetermined size; and
a strand guide controller unit configure to move the strand guide between the open position and the closed position based on a signal indicative of a location of the strand guide relative to the welding plate assembly.

8. A method, comprising:
determining a position of a welding plate assembly on a casting bed, the casting bed comprising a casting surface and a longitudinal axis, the welding plate being attached to at least one of one or more prestressed strands extending above the casting surface;
engaging the prestressed strands to support the prestressed strands above the casting surface while forming a hollow core element along the casting surface from concrete so as to embed the prestressed strands and the welding plate assembly in the concrete;
disengaging the prestressed strands at the welding plate assembly based on the position of the welding plate assembly; and
re-engaging the prestressed strands past the welding plate.

9. The method of claim 8, wherein the determining step comprises measuring the distance of the welding plate relative to a reference point.

10. The method of claim 9, wherein the measuring step further comprises moving a measuring device along the casting bed relative to a reference point.

11. The method of claim 9, wherein the measuring step further comprises directing a laser at a reflector positioned at one end of the casting bed.
